(19) United States
(12) Patent Application Publication
(10) Pub. No.: US 2018/0282619 A1
(43) Pub. Date: Oct. 4, 2018

(54) Reversible Continuous Variable Chromogenic Material, Preparation Method and Application thereof

(71) Applicant: Yancheng Institute of Technology, Yancheng (CN)

(72) Inventors: Xiuli YANG, Yancheng (CN); Minghua XIE, Yancheng (CN); Rong SHAO, Yancheng (CN); Rongfeng GUAN, Yancheng (CN); Wei CAI, Yancheng (CN)

(21) Appl. No.: 15/834,116

(22) Filed: Dec. 7, 2017

(30) Foreign Application Priority Data
Mar. 28, 2017 (CN) 201710192477.8

(51) Int. Cl. C09K 11/06; C07F 13/00

(52) U.S. Cl. CPC C09K 11/06; C07F 13/00; C07B 2200/13; C09K 2211/1011; C09K 2211/188

(57) ABSTRACT

The present disclosure discloses a reversible continuous variable chromogenic material, a preparation method as well as an application thereof. The present disclosure relates to a field of chromogenic material. The reversible continuous variable chromogenic material crystallizes in a trigonal R₃ space group. A fundamental asymmetric unit includes two 9,10-diacrylate anthracene ligands, two Mn²⁺ and ⅔ μ-O. A plurality of fundamental asymmetric units connect with each other and form a three dimensional infinite network structure. This material is a chromogenic metal-organic framework which performs continuous variable fluorescence color in a wide color gamut. A preparation technology for this reversible continuous variable chromogenic material is facile. A luminescent material with a range of fluorescence color change is obtained by adding various amounts of halogenated hydrocarbon into a n-hexane dispersion containing the reversible continuous variable chromogenic material during an application of the reversible continuous variable chromogenic material.

### TECHNICAL FIELD

The present disclosure relates to a field of chromogenic material, and specifically to a reversible continuous variable chromogenic material, a preparation method and an application thereof.

### BACKGROUND

In general, chromogenic materials exhibit various visible absorption changes or fluorescence emission changes under an external stimulation of electricity, light or pressure, which are widely used in fields of military, electronic devices and anti-counterfeit packaging. Chromogenic materials, according to their compositions, are divided into organic chromogenic materials, inorganic chromogenic materials and hybridized organic-inorganic chromogenic materials. Wherein the pure organic chromogenic materials or the inorganic chromogenic materials generally have one or more disadvantages of poor thermal stability, low luminous efficiency and narrow chromogenic range due to a single-component structure. However, the hybridized organic-inorganic chromogenic integrate stability of the inorganic chromogenic materials as well as function diversity of the organic chromogenic materials. Thus, the hybridized organic-inorganic chromogenic materials are very promising new chromogenic materials.

Among the most popular hybridized organic-inorganic materials, metal-organic frameworks (MOFs) perform a good atomic-level interaction between an organic luminescent center and an inorganic luminescent center via coordination. In addition to a relative high thermal stability thereof and a controllable three dimensional structure, MOFs exhibit a great potential of chromogenic applications. A metal-organic framework chromogenic material generally takes organic ligands and metal ions as two functional optical centers, and introduce other organic functional molecules or a secondary metal ion when necessary. Color changes are achieved by regulating behaviors of a ground state or an excited, state of a optical center through the external stimulation of pressure, electric field and solvent, etc. However, such method can only change the color of the material within a certain small light wavelength range, and the light wavelength range is too narrow to achieve obvious color change. Furthermore, the ambiguous color change is discrete rather than continuous, which dramatically limits the potential application. Therefore, there is an important practical significance for a development of a new reversible continuous variable chromogenic material workable in a wide light wavelength range.

### SUMMARY

A purpose of the present disclosure is to provide a reversible continuous variable chromogenic material, so that a continuous variable color change with a large range of light wavelength is achieved by a metal-organic framework, namely, the reversible continuous variable chromogenic material.

Another purpose of the present disclosure is to provide a method for preparing the reversible continuous variable chromogenic material, and a preparation technology is facile.

Another purpose of the present disclosure is to provide an application of the reversible continuous variable chromogenic material. A luminescent material with a range of fluorescence color change is obtained by adding Various amounts of halogenated hydrocarbon into the n-hexane dispersion containing the reversible continuous variable chromogenic material.

Technical solutions to solve the technical problem of the present disclosure are as follows.

The present disclosure provides a reversible continuous variable chromogenic material, characterized in that the reversible continuous variable chromogenic material crystallizes in a trigonal system with an R₃ space group. Preferably, the reversible continuous variable chromogenic material has a molecular formula of C₆₀H₃₆Mn₃O₁₃. The reversible continuous variable chromogenic material comprises a plurality of fundamental asymmetric units. The fundamental asymmetric unit comprises two L ligands, two Mn²⁺, and ⅔ μ-O. The L ligand is 9, 10-diacrylate anthracene.

Further, in a preferred embodiment of the present disclosure, each of two carboxyl groups of the L ligand takes a motif of bidentate coordination. Each of the two carboxyl groups bridges two different Mn²⁺ respectively. Each of the two different Mn²⁺ is hexa-coordinated; each of the two different Mn²⁺ coordinates with one μ-O and five oxygen atoms of five carboxyl groups of five different L ligands, forming an octahedral geometry.

Further, in a preferred embodiment of the present disclosure, each of the μ-O coordinates with three different Mn²⁺, forming a (Mn₃O)(COO)₃ secondary building unit arranged in a way of . . . ABAB . . . in parallel along a “c” axis.

Further, in a preferred embodiment of the present disclosure, different (Mn₃O)(COO)₃ secondary building units connect with each other by bidentate bridging of the carboxyl group, forming a unidimensional metal chain along the “c” axis.

Further, in a preferred embodiment of the present disclosure, each of the L ligands connects with two different (Mn₃O)(COO)₃ secondary building units by the carboxyl groups of L ligand respectively, stacked in the way of . . . ABAB . . . along the c axis. Each of the different (Mn₃O)(COO) secondary building units further connects with three different L ligands respectively, forming a three dimensional infinite network.

A preparation method of the reversible continuous variable chromogenic material of claim 1 comprises:
dissolving 9,10-diacrylate anthracene in a solvent and obtaining first solution of 2-10 mg/mL; the solvent is any one of N,N-dimethylformamide, N,N-dimethylacetamide, N,N-diethylformamide;
dissolving MnCl₂ or Mn(ClO₄)₂ in water and obtaining a second solution of 10-100 mg/mL;
mixing the first solution and the second solution in a proportion of 3:1-1:3, then adding a diluted acid with a H⁺ concentration of 0.2-1 mol/L and obtaining a mixed solution; and
sealing and heating the obtained mixed solution for 2-5 days under a heating temperature at 75° C.-95° C.

An application of the reversible continuous variable chromogenic material of claim 1, characterizes in that the reversible continuous variable chromogenic material is applied to obtain a luminescent material with a range of fluorescence color change detected by a fluorescence spectrophotometer.

Further, in a preferred embodiment of the present disclosure, a method for obtaining the luminescent material with a range of fluorescence color change comprises:
adding the reversible continuous variable chromogenic material into n-hexane and mixing evenly to prepare a dispersion with the reversible continuous variable chromogenic material at a concentration of 0.4-0.6 mg/mL;
adding different amounts of halogenated hydrocarbon to the n-hexane dispersion to obtain the luminescent material with a range of fluorescence color change, respectively.

Further, in a preferred embodiment of the present disclosure, the added halogenated hydrocarbon comprises one or more of 1,1,2-trichloroethane, tribromomethane and bromobenzene.

Further, in a preferred embodiment of the present disclosure, when the added halogenated hydrocarbon is 1,1,2-trichloroethane, a fluorescence emission wavelength of the reversible continuous variable chromogenic material ranges from 410 nm to 600 nm.

Beneficial effects of the reversible continuous variable chromogenic material, preparation method and application thereof in the present disclosure are as follows.

The reversible continuous variable chromogenic material crystallizes in a trigonal R₃ space group. Preferably, the reversible continuous variable chromogenic material has a molecular formula of C₆₀H₃₆Mn₃O₁₃. The reversible continuous variable chromogenic material includes a plurality of fundamental asymmetric units. The fundamental asymmetric unit includes two L ligands, two Mn²⁺, and ⅔ μ-O. The reversible continuous variable chromogenic metal-organic framework achieves a reversible continuous variable color-changing in a wide range of light wavelength. The preparation method of the reversible continuous variable chromogenic material includes preparing a first solution by dissolving 9,10-diacrylate anthracene in a solvent; dissolving MnCl₂ or Mn(ClO₄)₂ in water and obtaining a second solution of 10-100 mg/mL; mixing the first solution and the second solution in a proportion of 3:1-1:3, then adding a diluted acid and obtaining a mixed solution; sealing and heating the obtained mixed solution for 2-5 days, with a heating temperature at 75° C.-95° C. The preparation method is facile. When the reversible continuous variable chromogenic material is applied, the luminescent material with a range of fluorescence color change is obtained by adding various amounts of halogenated hydrocarbon into the n-hexane dispersion of reversible continuous variable chromogenic material.

### BRIEF DESCRIPTION OF DRAWINGS

In order to describe clearly the technical solutions of embodiments of the present disclosure, a brief introduction of drawings is given to describe the embodiments. It is to be understood that the following drawings merely illustrate same embodiments of the present disclosure and therefore, should not be regarded as a limitation of a scope of the present disclosure. For those skilled in the art, other related drawings may also be obtained based on the drawings mentioned above without any creative work.

FIG. 1 shows a schematic diagram of the fundamental asymmetric unit of the reversible continuous variable chromogenic material provided in the present disclosure.

FIG. 2 shows a three dimensional schematic diagram of the reversible continuous variable chromogenic material provided in the present disclosure.

FIG. 3 shows a Commission Internationale de L'Eclairage (CIE) coordinate diagram of fluorescence colors of the reversible continuous variable chromogenic material in a mixed solution with various proportions of n-hexane to 1,1,2-trichloroethane.

FIG. 4 shows a CIE coordinate diagram of fluorescence colors of the reversible continuous variable chromogenic material in a mixed solution with various proportions of n-hexane to tribromomethane.

FIG. 5 shows a CIE coordinate diagram of fluorescence colors of the reversible continuous variable chromogenic material in a mixed solution with various proportions of n-hexane to bromobenzene.

### DETAILED DESCRIPTION

In order to make objectives of embodiments, technical solutions, and advantages of the present disclosure clear, the technical solutions in the embodiments of the present disclosure are described below. In the embodiments, if specific conditions are not mentioned, embodiments are performed according to normal conditions or conditions suggested by a manufacturer. Reagents or instruments used, which are not specified in manufacturers, are all available conventional products through a commercial purchase.

The reversible continuous variable chromogenic material, the preparation method and the application thereof in the embodiments of the present disclosure are described in detail below.

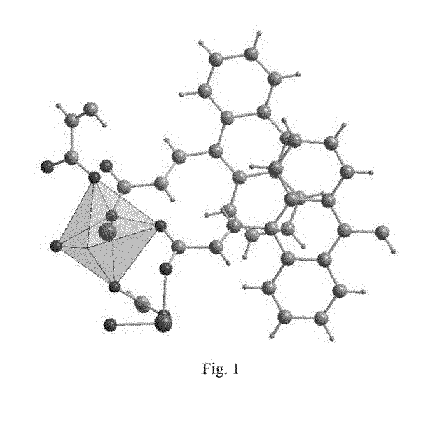

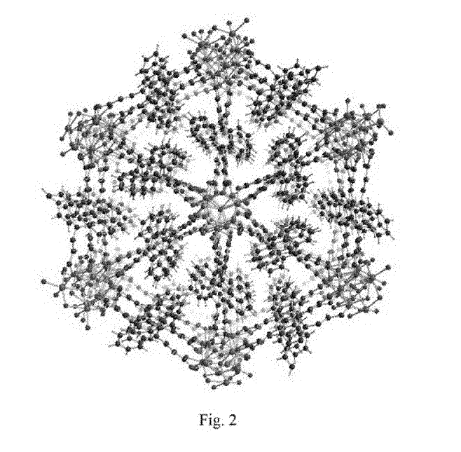

The reversible continuous variable chromogenic material, provided in the present disclosure, crystallizes in a trigonal R₃ space group. Preferably, the reversible continuous variable chromogenic material has a molecular formula of C₆₀H₃₆Mn₃O₁₃. The reversible continuous variable chromogenic material includes a plurality of fundamental asymmetric units. The fundamental asymmetric unit includes two L ligands, two and Mn²⁺, and ⅔ μ-O, and the L ligand is 9,10-diacrylate anthracene. Further, each of the two carboxyl groups of the L ligand takes a motif of bidentate coordination. Each of the two carboxyl groups bridges two different Mn²⁺. Each of the two different Mn²⁺ is hexa-coordinated. Each of the two different Mn²⁺ coordinates with one μ-O and five oxygen atoms of five carboxyl groups of five different L ligands, forming an octahedral geometry, which is shown in FIG. 1. Each of the μ-O coordinates with three different Mn²⁺, forming a (Mn₃O)(COO)₃ secondary building unit arranged in a way of . . . ABAB . . . in parallel along a “c” axis. Different (Mn₃O)(COO)₃ secondary building units connect with each other by bidentate bridging of the carboxyl group, forming a unidimensional metal chain along the “c” axis. Each of the L ligands connects with two different (Mn₃O)(COO)₃ secondary building units by the carboxyl groups of L ligand respectively, stacked in the way of . . . ABAB . . . alone the “c” axis. Each of the different (Mn₃O)(COO)₃ secondary building units further connect with three different L ligands respectively, forming a three dimensional infinite network, as shown in FIG. 2.

The preparation method of the reversible continuous variable chromogenic material includes:

S1. dissolving 9,10-diacrylate anthracene in a solvent and obtaining a first solution of 2-10 mg/mL; a solvent is any one of N,N-dimethylformamide, N,N-dimethylacetamide, N,N-diethylformamide; and dissolving MnCl₂ or Mn(ClO₄)₂ in water and obtaining a second solution of 10-100 mg/mL;

S2. mixing the first solution and the second solution in a proportion of 3:1-1:3, then adding a diluted acid with a H⁺ concentration at 0.2-1 mol/L, wherein the diluted acid is preferably a diluted nitric acid or a diluted hydrochloric acid and an adding amount of the diluted acid is 1-5 drops; obtaining a mixed solution;

S3. sealing and heating the obtained mixed solution for 2-5 days with a heating temperature at 75° C.-95° C. Preferably, the obtained mixed solution is sealed and heated in a glass spawn bottle. The target product is an orange needle crystal.

Polycyclic aromatic molecules have many unique optical properties. These molecules have a strong ππ stacking interaction, to enable an aggregation of molecules and result in Aggregation-Induced Emission (AIE), which are potentially excellent chromogenic materials. In general, the AIE effect requires that the luminescent molecules have a certain degree of free motion that facilitates interconversion between monomer-aggregate states. Integrating organic molecules into metal-organic frameworks leads to various performance enhancements, for example, it can effectively enhance its luminous efficiency, greatly reduce a non-radiative decay induced by intermolecular collisions. And a periodic three dimensional structure provides a possibility of in-depth study on their photophysical changes. However, since the organic molecules are fixed when the frame structure is formed, molecular motion or vibration is restricted in a very small amplitude, and it is difficult to satisfy a requirement of free molecular motion for the AIE effect. It has been no excellent case that color changes are achieved by a metal-organic framework.

On the other hand, intramolecular Charge Transfer (ICT) is another type of phenomenon often encountered in organochromic materials. It means that intramolecular electrons (eg π electrons) transfer from an aromatic ring to an electron-withdraw group. A molecular dipole is changed and significant luminous changes are achieved. In the meanwhile, the ICT effect does not necessarily depend on the molecular free movement such as twisting or folding.

The ligand of the reversible continuous variable chromogenic material of the present disclosure is a novel organic chromogenic molecule that has both the AIE and ICT effects. When aggregated the ligand shows an AIE effect, the it electrons of the aromatic ring are transferred to a specific group by the action of ICT, so that an original ππ stacking effect is interfered between aromatic rings and the ALE effect is impeded. Thus, a regulation of the AIE can be realized from a completely new perspective and a regulation of continuous variable chromogenic material is achieved. The AIE effect of this kind of molecule does not depend on the free molecular motions or distortions, so it can be applied to the metal-organic frameworks. Thermal stability is improved and an excellent AIE effect for color-changing is well maintained with reduced non-radiative decay and enhanced luminous efficiency.

The reversible continuous variable chromogenic material of the embodiments of the disclosure has a definite structure, a simple preparation process and strong practicability. The embodiments of the present disclosure innovatively combine an intramolecular charge transfer with aggregation-induced fluorescence to achieve an interconversion between free molecule fluorescence and exciplex fluorescence in a limited space. The range of the fluorescence color wavelength is wide, covering most of the visible light area from blue light to yellow light. A ratio of the free molecule luminescence to the exciplex luminescence can be tuned precisely by controlling an exact ratio of the external solvent. The reversible continuous variable chromogenic material exhibits blue fluorescence in n-hexane, originating from the free molecular luminescence; and exhibits orange fluorescence in halogenated hydrocarbon, originating from the exciplex fluorescence. The luminescence of the reversible continuous variable chromogenic material can be regulated discretionarily in a continuous variable mode from blue to yellow region. The interconvertion between free molecular fluorescence and exciplex fluorescence is rapid and reversible, which can be achieved by tuning the ratio of external dispersed solvent, ie, n-hexane and halogenated hydrocarbons, so a rapid response is obtained and the change is reversible. It is a first intelligent chromatic-crystalline material that the luminescence of materials is regulated by regulating the aggregation effects.

A luminescence principle of the reversible continuous variable chromogenic material in the embodiments of the present disclosure is as follows.

Anthracene molecule itself has a typical AIE effect, exhibiting blue fluorescence with a maximum wavelength of 410 nm of the monomer as well as orange fluorescence of a maximum wavelength of about 600 nm based on the AIE effect. When electron-withdrawing acrylic groups are introduced, the acrylic groups coordinate with Mn²⁺ to form metal-organic frameworks. The formed (Mn₃O)(COO)₃ metal carboxyl cluster has a strong electron-withdrawing effect and effectively attracts the π electrons of anthracene rings, interfering an original ππ stacking between the anthracene rings and hindering the AIE effect. On the other hand, a three dimensional framework is formed through the coordination with Mn²⁺, and different ligands stack together in a parallel manner to meet the requirements of a molecular structure and the spatial configuration for the AIE effect. However, the reversible continuous variable chromogenic material does not exhibit the AIE effect under normal conditions. Theoretical calculations based on a molecule containing the structure unit of six L ligands (Gaussian 09, DFT-B3LYP/6-31G), has shown that HOMO and LUMO are almost located on the carboxyl groups and metal ions rather than on the anthracence rings. This phenomenon fully illustrates that an ICT effect that the acrylic group attracts the π electrons of the anthracene rings. Therefore, after the introduction and coordination of the carboxyl groups with Mn²⁺, the original AIE effect between the anthracene rings almost disappears, merely exhibiting the blue fluorescence originated from the π-π* transition of independent anthracene rings.

The present embodiments also provides the application of the reversible continuous variable chromogenic material to obtaining the luminescent material with a range of fluorescence color change. The method thereof includes:
adding the reversible continuous variable chromogenic material into n-hexane and mixing evenly to prepare a dispersion solution with a concentration of the reversible continuous variable chromogenic material at 0.4-0.6 mg/mL;
adding different amount of different halogenated hydrocarbon to the n-hexane dispersion to obtain the luminescent material with different fluorescence emission colors, respectively.

Wherein, the added halogenated hydrocarbon includes one or more of 1,1,2-trichloroethane, tribromomethane, bromobenzene.

When the added halogenated hydrocarbon is 1,1,2-trichloroethane, a fluorescence emission wavelength of the reversible continuous variable chromogenic material ranges from 410 nm to 600 nm. A principle of a continuous variable color-changing is as follows.

When the reversible continuous variable chromogenic material is in an environment of 1,1,2-trichloroethane, Cl atom interacts with the carboxyl group, which attracts electrons, since the Cl atom itself uses only one 3pz orbital to form a sigma bond with a C atom, with two free orbitals of 3px and 3py, each of which contains 2 paired electrons, The paired electrons replace the π-electrons of the anthracene rings, thus weakening the attraction of the π-electrons of the anthracene rings by the carboxyl groups. The π-electrons go back to the anthracene rings, interrupting the original ICT effect on the L ligand and prompting a regeneration of a strong RR stacking effect between the adjacent paralleled anthracene rings. Therefore the AIE effect appears once again.

In the meantime, since n-hexane has no vacant valence electron and can not interact with the electron-attracting carboxyl group. 1,1,2-trichloroethane interacts with carboxyl groups as an electron donor. Therefore, the L ligand can perform a complete ICT effect in a n-hexane environment. If a ratio of 1,1,2-trichloroethane to n-hexane is adjusted, a relative ratio of ICT effect to AIE effect of L ligand is regulated. And an interconversion between monomer fluorescence and aggregation fluorescence is achieved. Thus continuous adjusting of the fluorescence color of the reversible continuous variable chromogenic material is achieved in a light wavelength range of 410-600 nm.

The features and performances of the present disclosure are further described in detail below with reference to the embodiments.

### Embodiment 1

The embodiment 1 provides a reversible continuous variable chromogenic material, wherein a preparation process thereof includes as follows.

20 mg of 9,10-diacrylate anthracene was dissolved in 10 mL of N,N-dimethylformamide.

A first solution of 2 mg/mL was prepared.

100 mg of MnCl₂ was dissolved in 10 mL water and a second solution of 10 mg/mL was obtained.

9 mL of the first solution and 3 mL of the second solution were mixed together. Then 5 drops were added of a diluted nitric acid with a H⁺ concentration at 0.2 mol/L. A mixed solution was obtained.

The obtained mixed solution was sealed and heated for 2 days in a glass spawn bottle, with a heating temperature at 95° C. A target product of an orange needle crystal was obtained, which is the reversible continuous variable chromogenic material.

The fluorescence color change of the reversible continuous variable chromogenic material is also provided in the embodiment 1, wherein the method thereof includes as follows.

0.5 mg of the reversible continuous variable chromogenic material was placed in a 1 cm×1 cm quartz cell, and 1 mL of n-hexane was added and mixed evenly to prepare a dispersion.

Pure 1,1,2-trichloroethane was added to the dispersion in 14 times, and 1,1,2-trichloroethane was thoroughly mixed with n-hexane each time to obtain the luminescent material with a range of fluorescence color change. The total volume of 1,1,2-trichloroethane in the dispersion after each addition is 100 μL, 300 μL, 600 μL, 1000 μL, 1100 μL, 1200 μL, 1300 μL, 1400 μL, 1500 μL, 1600 μL, 1700 μL, 1800 μL, 1900 μL and 2000 μL.

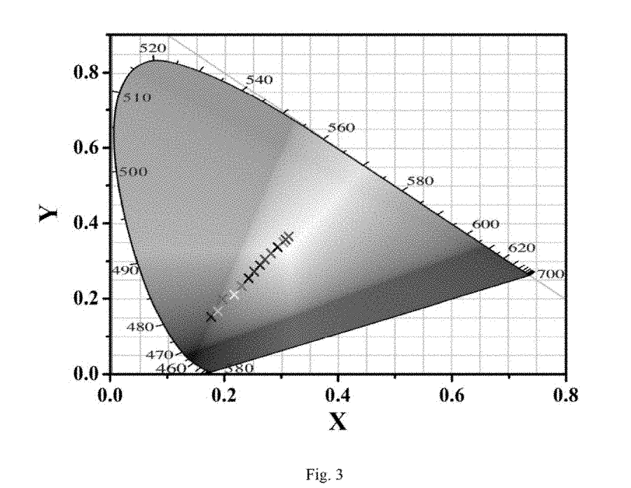

Fluorescence spectrophotometer was used to detect a fluorescence spectrum of the reversible continuous variable chromogenic material after adding 1,1,2-trichloroethane each time. An excitation wavelength of the fluorescence spectrophotometer was set at 370 nm with a seaming range of 400-700 nm. The fluorescence emission spectrum of the corresponding reversible continuous variable chromogenic material was recorded. FIG. 3 shows a Commission Internationale de L'Eclairage (CIE) coordinate diagram of fluorescence colors of the reversible continuous variable chromogenic material in a mixed solution with a various proportions of n-hexane to 1,1,2-trichloroethane. As shown in FIG. 3, with a gradual addition of 1,1,2-trichloroethane, the fluorescence color of the reversible continuous variable chromogenic material changes gradually from pure blue to cyan, white, green, until yellow, with a light wavelength covering from 410 nm to 600 nm.

### Embodiment 2

The embodiment 2 provides a reversible continuous variable chromogenic material, wherein a preparation process thereof includes as follows.

100 mg of 9,10-diacrylate anthracene was dissolved in 10 mL of N,N-dimethylacetamide.

A first solution of 10 mg/mL was prepared.

1 g of Mn(ClO₄)₂ was dissolved in 10 mL water and a second solution of 100 mg/mL was obtained.

3 mL of the first solution and 9 mL of the second solution were mixed together. Then 1 drop was added of a diluted hydrochloric acid with a H⁺ concentration at 1 mol/L. A mixed solution was obtained.

The obtained mixed solution was sealed and heated for 5 days in a glass spawn bottle, with a heating temperature at 75° C. A target product of an orange needle crystal is obtained, which is the reversible continuous variable chromogenic material.

The fluorescence color change of the reversible continuous variable chromogenic material is also provided in the embodiment 2, wherein the method thereof includes as follows.

0.4 mg of the reversible continuous variable chromogenic material was placed on a 1 cm×1 cm quartz cell, and 1 mL of n-hexane was added and mixed evenly to prepare a dispersion.

Pure tribromomethane was added to the dispersion in 8 times, and tribromomethane was thoroughly mixed with n-hexane after each addition to obtain the luminescent material with a range of fluorescence color change. The total volume of tribromomethane in the dispersion after each addition is 0.1 μL, 0.3 μL, 0.5 μL, 0.6 μL, 0.7 μL, 0.8 μL, 1 μL, 5 μL.

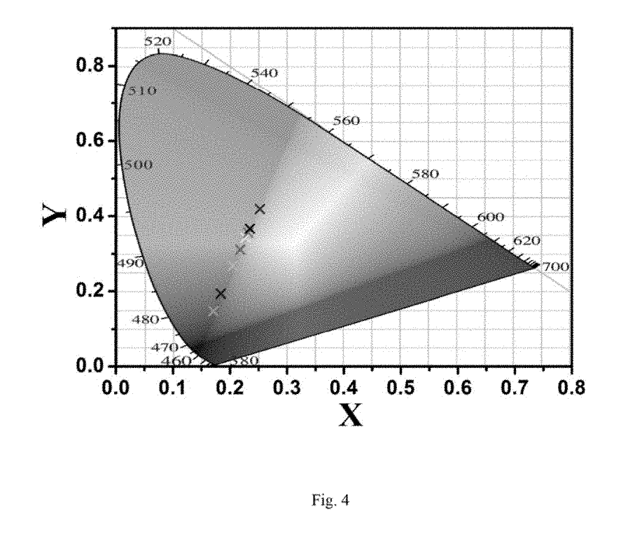

Fluorescence spectrophotometer was used to detect a fluorescence spectrum of the corresponding reversible continuous variable chromogenic materials after adding tribromomethane each time. An excitation wavelength of the fluorescence spectrophotometer was set at 370 nm with a scanning range of 400-700 nm. The fluorescence emission spectrum of the corresponding reversible continuous variable chromogenic material was recorded. FIG. 4 shows a CIE coordinate diagram of colors of the reversible continuous variable chromogenic material in a mixed solution with a various proportions of n-hexane to tribromomethane. As shown in FIG. 4, with a gradual addition of tribromomethane, the fluorescence color of the reversible continuous variable chromogenic material changes gradually from pure blue to cyan, green, until yellow green, with a light wavelength covering from 410 nm to 580 nm.

### Embodiment 3

The embodiment 3 provides a reversible continuous variable chromogenic material, wherein a preparation process thereof includes as follows.

50 mg of 9,10-diacrylate anthracene was dissolved in 10 mL of N,N-diethylformamide.

A first solution of 5 mg/mL was prepared.

500 mg of MnCl₂ was dissolved in 10 mL water and a second solution of 50 mg/mL was obtained.

5 mL of the first solution and 5 mL of the second solution were mixed together. Then 2 drops were added of a diluted nitric acid with a H⁺ concentration at 0.5 mol/L. A mixed solution was obtained.

The obtained mixed solution was sealed and heated for 4 days in a glass spawn bottle, with a heating temperature at 80° C. A target product of an orange needle crystal was obtained, which is the reversible continuous variable chromogenic material.

The fluorescence color change of the reversible continuous variable chromogenic material s also provided in the embodiment 3, wherein the method thereof includes as follows.

0.6 mg of the reversible continuous variable chromogenic material was placed in a 1 cm×l cm quartz cell, and 1 mL of n-hexane was added and mixed evenly to prepare a dispersion.

Pure bromobenzene was added to the dispersion in 13 times, and bromobenzene was thoroughly mixed with n-hexane after each addition to obtain the luminescent material with a range of fluorescence color change. The total volume of bromobenzene in the dispersion after each addition is 50 μL, 100 μL, 200 μL, 300 μL, 400 μL, 500 μL, 600 μL, 700 μL, 750 μL, 800 μL, 850 μL, 900 μL, 1000 μL.

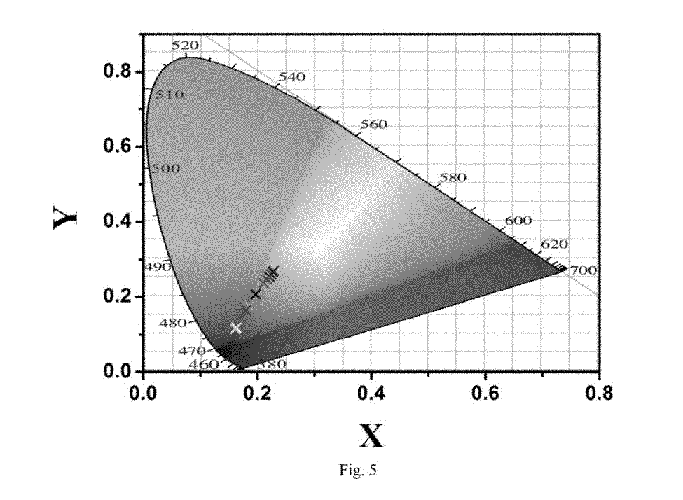

Fluorescence spectrophotometer was used to detect a fluorescence spectrum of the corresponding the reversible continuous variable chromogenic material after adding tribromomethane each time. An excitation wavelength of the fluorescence spectrophotometer was set at 370 nm with a scanning range of 400-700 nm. The fluorescence emission spectrum of the corresponding the reversible continuous variable chromogenic material was recorded. FIG. 5 shows a CIE coordinate diagram of fluorescence colors of the reversible continuous variable chromogenic material in a mixed solution with a various proportions of n-hexane to bromobenzene. As shown in FIG. 5, with a gradual addition of tribromomethane, the fluorescence color of the reversible continuous variable chromogenic material changes gradually from pure blue to cyan, until green, with a light wavelength covering from 410 nm to 550 nm.

In all, the reversible continuous variable chromogenic material in the embodiments of the present disclosure can realize a wide range of reversible continuous variable fluorescence color changing. The preparation method of the reversible continuous variable chromogenic material is facile. When the reversible continuous variable chromogenic material is applied, the luminescent material with a range of fluorescence color change is obtained by adding various amounts of halogenated hydrocarbon into the n-hexane dispersion of the reversible continuous variable chromogenic material.

The described embodiments are only a part but not all of the embodiments of the present disclosure. The detailed description of the embodiments of the disclosure is not intended to limit the scope of the disclosure, but merely to present selected embodiments of the disclosure. All other embodiments obtained based on the embodiments of the present disclosure by those skilled in the art without creative efforts shall fall within a protection scope of the present disclosure.

What is claimed is:

1. A reversible continuous variable chromogenic material, characterized in that the reversible continuous variable chromogenic material crystallizes in a trigonal R₃ space group;
the reversible continuous variable chromogenic material comprises a plurality of fundamental asymmetric units;
the fundamental asymmetric unit comprises two L ligands, two Mn²⁺, and ⅔ μ-O; and
the L ligand is 9,10-diacrylate anthracene.

2. The reversible continuous variable chromogenic material according to claim 1, characterized in that each of two carboxyl groups of the L ligand takes a motif of bidentate coordination;
each of the two carboxyl groups bridges two different Mn²⁺ respectively; each of the two different Mn²⁺ is hexa-coordinated; and
each of the two different Mn²⁺ coordinates with one μ-O and five oxygen atoms of five carboxyl groups of five different L ligands, fanning an octahedral geometry.

3. The reversible continuous variable chromogenic material according to claim 1, characterized in that each of the μ-O coordinates to three different Mn²⁺, forming a (Mn₃O)(COO)₃ secondary building unit arranged in a way of . . . ABAB . . . in parallel along a “c” axis.

4. The reversible continuous variable chromogenic material according to claim 3, characterized in that different (Mn₃O)(COO)₃ secondary building units connect with each other by bidentate bridging of the carboxyl group, forming a unidimensional metal chain along the “c” axis.

5. The reversible continuous variable chromogenic material according to claim 3, characterized in that each of the L ligands connects respectively with two different (Mn₂O)(COO)₃ secondary building units by the carboxyl groups of the L ligand, stacked in the way of . . . ABAB . . . along the “c” axis; and
each of the different (Mn₃O)(COO)₃ secondary building units further connects respectively with three different L ligands forming a three dimensional infinite network.

6. A preparation method of the reversible continuous variable chromogenic material of claim 1, comprising:
dissolving 9,10-diacrylate anthracene in a solvent and obtaining a first solution of 2-10 mg/mL;
the solvent is any one of N,N-dimethylformamide, N,N-dimethylacetamide, N,N-diethylformamide;
dissolving MnCl₂ or Mn(ClO₄)₂ in water and obtaining a second solution of 10-100 mg/mL;
mixing the first solution and the second solution in a proportion of 3:1-1:3, then adding a diluted acid with a H⁺ concentration of 0.2-1 mol/L and obtaining a mixed solution; and
sealing and heating the obtained mixed solution for 2-5 days under a heating temperature at 75° C.-95° C.

7. An application of the reversible continuous variable chromogenic material of claim 1, characterized in that the reversible continuous variable chromogenic material is used to obtain a luminescent material with a range of fluorescence color change.

8. The application of the reversible continuous variable chromogenic material according to claim 7, characterized in that a method for obtaining the luminescent material with a range of fluorescence color change comprises:
adding the reversible continuous variable chromogenic material into n-hexane and mixing evenly to prepare a dispersion with the reversible continuous variable chromogenic material at a concentration of 0.4-0.6 mg/mL;
adding various amounts of halogenated hydrocarbon to the n-hexane dispersion to obtain the luminescent material with a range of fluorescence color change of the reversible continuous variable chromogenic material, respectively.

9. The application of the reversible continuous variable chromogenic material according to claim 8, characterized in that the added halogenated hydrocarbon comprises one or more of 1,1,2-trichloroethane, tribromomethane and bromobenzene.

10. The application of the reversible continuous variable chromogenic material according to claim 9, characterized in that when the added halogenated hydrocarbon is 1,1,2-trichloroethane, a fluorescence emission wavelength of the obtained luminescent material ranges from 410 nm to 600 nm.
